(19) United States
(12) Patent Application Publication
(10) Pub. No.: US 2015/0158245 A1
(43) Pub. Date: Jun. 11, 2015

(54) ULTRASONIC BONDING OF A COVER GLASS SUB-ASSEMBLY

(71) Applicant: Apple Inc., Cupertino, CA (US)

(72) Inventors: DANIEL W. JARVIS, Sunnyvale, CA (US); Ian A. Spraggs, San Francisco, CA (US); Lee E. Hooton, Cupertino, CA (US); Miguel C. Christophy, San Francisco, CA (US); Richard Hung Minh Dinh, Saratoga, CA (US)

(73) Assignee: Apple Inc., Cupertino, CA (US)

(21) Appl. No.: 14/221,170

(22) Filed: Mar. 20, 2014

Related U.S. Application Data
(60) Provisional application No. 61/914,324, filed on Dec. 10, 2013.

(51) Int. Cl. B29C 65/08; B32B 17/06

(52) U.S. Cl. CPC B29C 65/08; B32B 17/06; B29L 2031/3475

(57) ABSTRACT

A method of using ultrasonic energy to secure a first and a second component is described, and an apparatus formed therefrom. A first layer is bonded to a second layer by converting ultrasonic energy into thermal energy. The energy conversions means is an energy director. A thermally sensitive layer receives the thermal energy and at least a portion of the thermally sensitive layer melts. The resultant melting bonds the first layer with the second layer. A different energy director may also be included and used to convert thermal energy in order to de-bond the first layer from the second layer in order to perform, for example, a rework.

### CROSS-REFERENCE TO RELATED APPLICATIONS

This application claims the benefit of priority under 35 U.S.C §119(e) to U.S. Provisional Application No. 61/914,324, filed on Dec. 10, 2013, the disclosure of which is incorporated herein by reference in its entirety.

### FIELD

This disclosure relates generally to display devices and more particularly to using ultrasonic welding techniques to secure components of a cover glass assembly used to protect an underlying display assembly.

### BACKGROUND

Many electronic devices include display assemblies that are used to present visual content. Generally, the display assembly includes a display unit having an electronic display having display elements (also referred to as picture elements, or pixels). The display elements can be easily damaged by errant contact or rough handling (such as occurs during a drop event) or can be rendered unreliable in the face of environmental contamination such as dust or moisture. Therefore, the display elements are overlaid by a series of protective layers used to provide protection against damage cause by either or both handling and the environment. The protective layers are generally coupled to a frame assembly by way of an adhesive, such as pressure sensitive adhesive, or PSA. However, in order to minimize the possibility of the PSA (or whatever adhesive is used) from marring the appearance of the electronic device (for example, too much adhesive or mis-located adhesive can overflow a designated area onto the transparent cover glass). These types of visible defects can detract from the cosmetic appearance of the part.

### SUMMARY

In one aspect, a method of using ultrasonic energy to secure a first and a second component is described. The method is carried out by forming a laminate structure comprising a plurality of layers at least one of which is an adhesive layer where at least one of the first and second components includes an array of ultrasonic energy directors configured to provide thermal energy in response to incident ultrasonic energy, positioning the laminate structure relative to the first and second components, and exposing the laminate structure to the incident ultrasonic energy causing at least some of the array of ultrasonic energy directors to emit thermal energy sufficient to melt associated portions of the laminate structure resulting in a corresponding bond between the first and second components.

In another aspect, a method of securing a cover glass to a frame member is described. The method is carried out by providing ultrasonic energy to a laminate structure which includes the cover glass, the frame member, and a thermally sensitive layer disposed between the cover glass and the frame member, and providing ultrasonic energy to a first energy director positioned on at least the one of the cover glass or the frame member, the first energy director configured to convert at least some of the ultrasonic energy to thermal energy, the thermal energy emitted from the first energy director melts a portion of the thermally sensitive layer thereby bonding the cover glass to the frame member.

In another aspect, a laminate structure is described. The laminate structure includes a first layer, a second layer, a first energy director configured to receive ultrasonic energy and convert at least some of the ultrasonic energy into thermal energy, and a thermally sensitive layer. A portion of the thermally sensitive layer melts in response to the thermal energy in order to bond the first layer to the second layer.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, assemblies, methods, and systems. These drawings in no way limit any changes in form and detail that may be made to the disclosure by one skilled in the art without departing from the spirit and scope of the disclosure.

FIG. 1 shows a top view of a portable computing device in accordance with the described embodiments;

FIG. 2 shows an exploded view of a display assembly in accordance with the described embodiments;

FIG. 3 shows an embodiment of an energy director;

FIG. 4 shows another embodiment of an energy director;

FIG. 5 shows a cross section of a display assembly in accordance with the described embodiments;

FIG. 6 shows an ultrasonic welding process of a display assembly in accordance with the described embodiments; and

FIG. 7 shows a flow chart detailing a process in accordance with a described embodiment.

### DETAILED DESCRIPTION

Representative applications of methods according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

A method of using ultrasonic energy to bond a first and second component using a laminate structure disposed between the first and second components is described. In one embodiment, at least some of the ultrasonic energy is received at receptors positioned within or in proximity to the laminate structure. The receptors can have a size and shape that cooperates with the directed ultrasonic energy to emit thermal energy of sufficient magnitude to melt a corresponding portion of the laminate structure. The melting of the corresponding portion of the laminate structure can form a bond between the first and second components. In this way, components not generally suitable for attachment using conventional adhesives or ultrasonic bonding alone can nonetheless be attached to each other forming a robust and environmentally secure seal.

In a particular embodiment, a method is described for securing a cover glass assembly to a frame (generally formed of plastic) forming part of a display module configured for presenting visual content. In some embodiments, the display module can be associated with a portable computing device that can take many forms such as a tablet computer, smart phone and so on. Moreover, the portable computing device can include at a least single piece housing. The single piece housing can be used to enclose and support a plurality of operational components (such as the display module) used to provide a desired set of functions. In particular embodiments, the display module can include the cover glass that can be bonded to a display frame using ultrasonic energy directed at receptors disposed within or in proximity to the laminate structure. The receptors can absorb at least some of the directed ultrasonic energy that is then converted to thermal energy. The thermal energy can cause at least a portion of the laminate structure to melt resulting in a bond formation between the frame and cover glass. In one embodiment, the laminate structure can include an optically clear adhesive layer and an optically clear plastic layer. The optically clear adhesive layer can be disposed between the cover glass and the optically clear plastic layer. In this way, the optically clear adhesive layer can provide mechanical support for the cover glass and enhance the bond formation between the cover glass and the frame.

Selected portions of the display frame can include an array of receptors hereinafter referred to as ultrasonic energy directors arranged to convert ultrasonic energy to thermal energy used to melt corresponding portions of the laminate structure. In some embodiments, a first set of ultrasonic energy directors can be positioned on the frame in a first pattern and be configured to convert ultrasonic energy at a first frequency range to a corresponding amount of thermal energy. In one embodiment, the first frequency range can include ultrasonic energy having an approximate frequency of 30 kHz. In other embodiments, a second set of ultrasonic energy directors can be positioned on the frame in a second pattern and/or be configured to convert ultrasonic energy to thermal energy at a second frequency range. In this way, during an assembly process, the first set of energy directors can be used to the melt selected portions of the laminate structure to form the bond between the cover glass and the frame. However, during a rework process, the bond between the cover glass and frame can be weakened such that the cover glass and frame can be separated from each other without causing undue damage. Accordingly, during the rework process, ultrasonic energy at the second frequency range can be directed at the second set of energy directors that can generate sufficient thermal energy to weaken the bond between the cover glass and the frame.

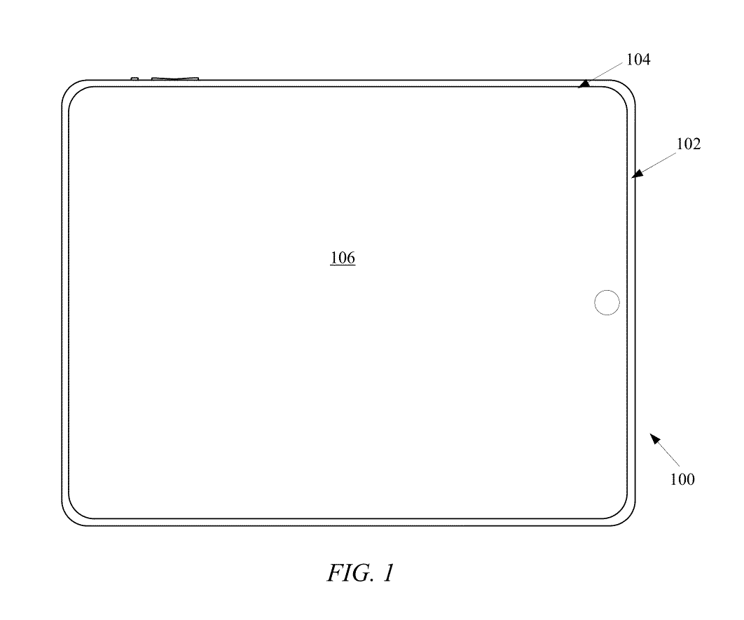

FIG. 1 illustrates a specific embodiment of portable computing device 100. More specifically, FIG. 1 shows a full top view of fully assembled portable computing device 100. Portable computing device 100 can process data and more particularly media data such as audio, video, images, etc. By way of example, portable computing device 100 can generally correspond to a device that can perform as a music player, game player, video player, personal digital assistant (PDA), tablet computer, or a combination thereof. With regards to being handheld, portable computing device 100 can be held in one hand by a user while being operated by the user's other hand (i.e., no reference surface such as a desktop is needed). For example, the user can hold portable computing device 100 in one hand and operate portable computing device 100 with the other hand by, for example, operating a volume switch, a hold switch, or by providing inputs to a touch sensitive surface such as a display or pad.

Portable computing device 100 can include single piece seamless housing 102 that can be formed of any number of materials such as plastic or metal that can be forged, molded, or otherwise processed into a desired shape. In those cases where portable computing device 100 has a metal housing and incorporates RF (radio frequency) based functionality, it may be advantageous to provide at least a portion of housing 102 in the form of radio (or RF) transparent materials such as ceramic, or plastic. In any case, housing 102 can be configured to at least partially enclose any suitable number of internal components associated with the portable computing device 100. For example, housing 102 can enclose and support internally various structural and electrical components (including integrated circuit chips and other circuitry) to provide computing operations for portable computing device. The integrated circuits can take the form of chips, chip sets, modules any of which can be surface mounted to a printed circuit board, or PCB, or other support structure. For example, a main logic board (MLB) can have integrated circuits mounted thereon that can include at least a microprocessor, semi-conductor (such as FLASH) memory, various support circuits and so on.

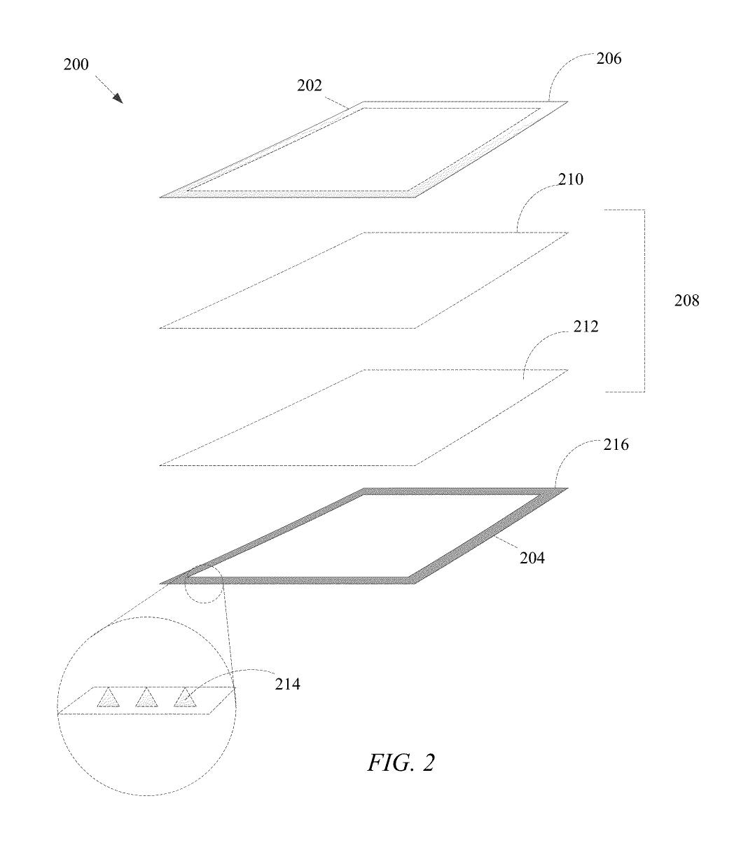

Housing 102 can include opening 104 for placing internal components and may be sized to accommodate a display assembly 200 (see FIG. 2) or system suitable for providing a user with at least visual content as for example via a display. In some cases, the display assembly can include touch sensitive capabilities providing the user with the ability to provide tactile inputs to portable computing device 100 using touch inputs. The display assembly can be formed of a number of layers including a topmost layer being a transparent protective layer 106 formed of polycarbonate or other appropriate plastic or highly polished glass. Using highly polished glass, transparent protective layer 106 can take the form of cover glass 106 substantially filling opening 104.

FIG. 2 shows a cross section of display assembly 200 in accordance with the described embodiments. Display assembly 200 can be sized in accordance with opening 104 and used to present visual content by portable computing device 100. More specifically, display assembly 200 can include cover glass 202 used to provide protection to underlying display elements used to provide visual content. Cover glass 202 can be formed of optically clear material such as glass or plastic. Display assembly 200 can also include a number of layers used to support cover glass 202 as well as provide a bonding medium for attachment of cover glass 202 to frame 204. For example, in order to prevent the liquid adhesive from over running cover glass attach area 206 (area used to bond to cover glass 202), conventional assembly techniques rely upon a pre-curing operation that partially cures the liquid adhesive. Although the partially cured liquid adhesive has a reduced tendency to over run attach area 206 (and thus mar the appearance of portable computing device 100), the likelihood of forming an impaired bond is increased. The impaired bond can result in an increased possibility of problems associated with contamination by dust particles, moisture, etc. or by increasing the likelihood of delamination of display assembly 200 due to external events, such as those associated with a drop event.

Accordingly, laminate structure 208 can be used to provide precision bonding between cover glass 202 and frame 204. The precision bonding can be accomplished without adhesive over run associated with conventional techniques. In one embodiment, laminate structure 208 can include optically clear adhesive layer 210 attached to an underside portion of cover glass 202. In this way, adhesive layer 210 can provide mechanical support for cover glass 202 as well as enhance the bond formed between laminate structure 208 and frame 204. In some embodiments, laminate structure 208 can also include optically clear plastic layer 212. In some cases, optically clear adhesive layer 210 can be disposed between optically clear plastic layer 212 and cover glass 202. Ultrasonic energy directors 214 can be arranged in specific patterns and positioned at specific locations on frame 204 within frame attach area 216. During an assembly operation, ultrasonic energy corresponding to a pre-determined frequency range can be directed at the ultrasonic energy directors 214. At least some of the directed ultrasonic energy can be absorbed by ultrasonic energy directors 214 in a manner that causes ultrasonic energy directors 214 to melt and/or emit thermal energy. The thermal energy in turn causes a corresponding portion of laminate structure 208 to melt resulting in a bond formation between cover glass 202 and frame 204 mediated by the melted portions of laminate structure 208.

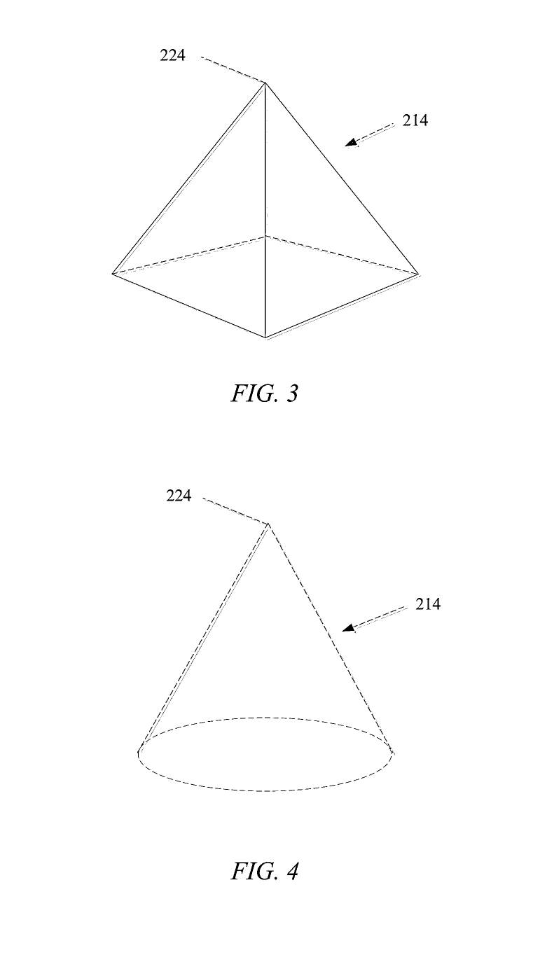

In some embodiments, ultrasonic energy directors 214 can have a size and shape in accordance with a specific range of ultrasonic energy. For example, as shown in FIGS. 3 and 4, ultrasonic energy directors 214 have a pyramidal shape having an apex region and a base region.

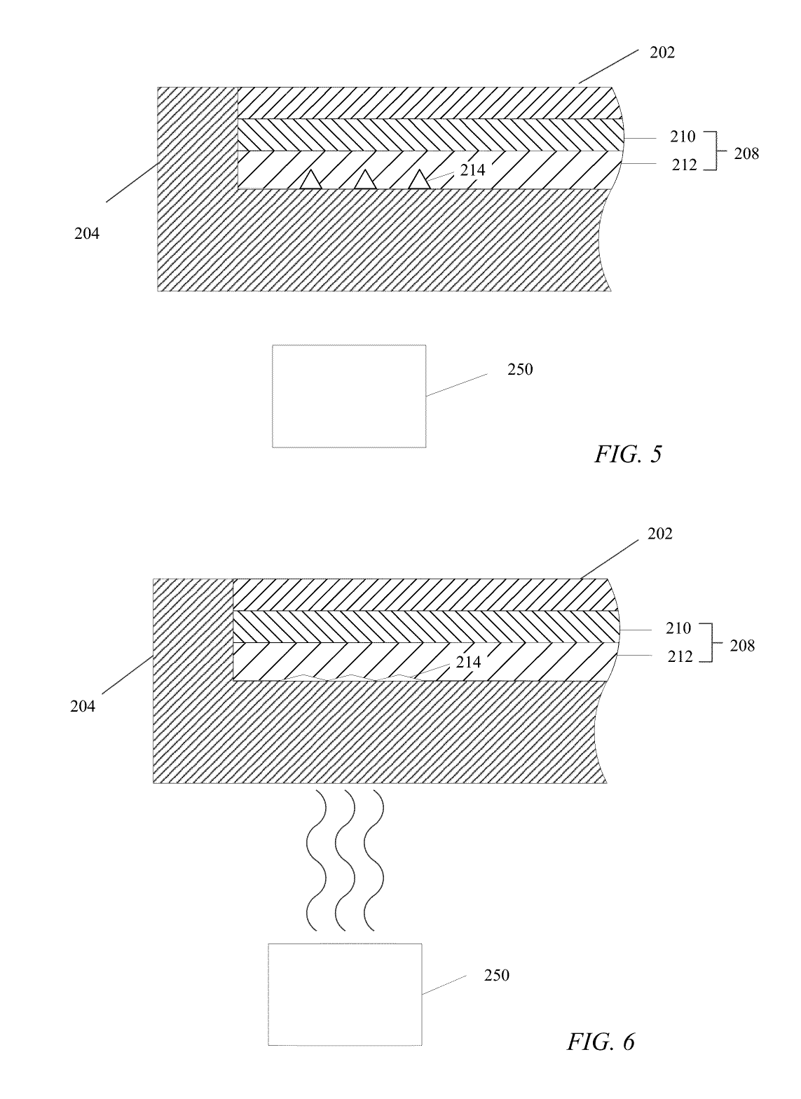

The apex region 224 of energy directors 214 concentrates incident ultrasonic energy from an ultrasonic energy source 250 (shown in FIGS. 5 and 6), thereby causing each energy director to melt from the apex region down to the corresponding base region forming a flattened structure that emits sufficient thermal energy to melt a corresponding portion laminate structure 208 including both optically clear plastic layer 212 and optically clear adhesive layer 210. In this way, the location, size, and shape of energy directors 214 can be used to selectively bond portions of frame 204 and cover glass 202 in a precise manner. FIG. 6 illustrates energy directors 214 being flattened, or melted, after sufficient ultrasonic energy is applied.

Accordingly, judicious placement of ultrasonic energy directors 214 can be enhance bond strength at specific locations prone to excess stress during abnormal use events (such as being dropped). For example, ultrasonic energy directors 214 can be positioned at a specific angle (such as 45 degrees) with respect to an external featured (such as a corner) to promote bond formation. In this way, those portions of display assembly 200 (such as those associated with a corner region) susceptible to damage caused by abnormal use events can be bolstered to reduce the possibility of, for example, delamination.

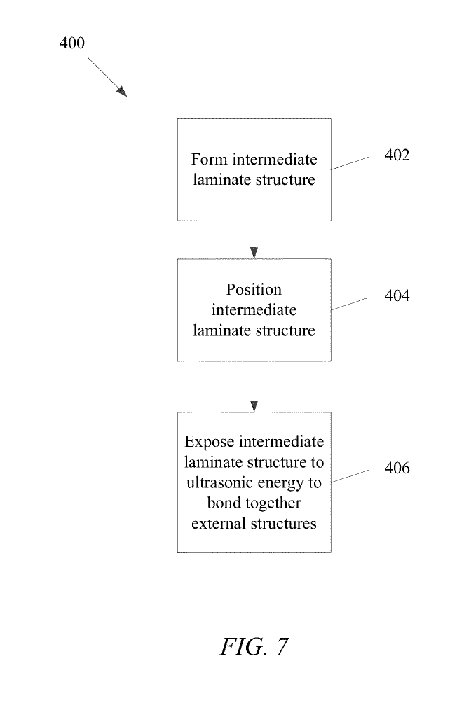

FIG. 7 shows a flowchart detailing process 400 in accordance with the described embodiments. More specifically, at 402, an intermediate laminate structure is formed. The intermediate laminate structure can be formed in many ways. For example, referring to FIG. 2, the intermediate laminate structure can be formed by attaching adhesive layer 210 to cover glass 202 that, in turn, can be attached to plastic layer 212 (via adhesive layer 210). In another embodiment, the laminate structure can be formed by die cutting adhesive layer 210 and plastic layer 212. The laminate structure can then be attached to cover glass 202 for ultrasonic bonding to frame 204. At 404, the intermediate structure positioned for bonding. At 406, the laminate structure is exposed to ultrasonic energy at a frequency range suitable for causing energy directors to emit thermal energy sufficient to melt selected portions of the laminate structure resulting in a bond formation between the cover glass and frame mediated by the melted portions of the laminate structure. In some embodiments, a rework operation can include exposed an assembly part to ultrasonic energy at a different frequency having the effect of weakening the adhesive bond allowing for easy removal of the display assembly from the frame.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method of using ultrasonic energy to secure a first component and a second component, comprising:
forming a laminate structure comprising a plurality of layers at least one of which is an optically clear plastic layer, wherein at least one of the first component and second component includes an array of ultrasonic energy directors configured to emit thermal energy in response to received ultrasonic energy;
positioning the laminate structure between the first component and second component; and
exposing the laminate structure to the ultrasonic energy causing at least some of the array of ultrasonic energy directors to emit thermal energy sufficient to melt a portion of the optically clear plastic layer resulting in a bond between the first component and the second component.

2. The method as recited in claim 1, wherein the first component comprises a cover glass suitable for overlaying a display element used to present visual content.

3. The method as recited in claim 1, wherein the second component comprises a display frame having a size and shape configured to receive the cover glass, and wherein the array of ultrasonic energy directors include a first set of ultrasonic energy directors arranged in a first pattern and arranged to convert the ultrasonic energy at a first frequency to a corresponding amount of thermal energy used to melt the portion of the optically clear plastic layer to form the bond in an assembly operation.

4. The method as recited in claim 3, the laminate structure comprising an adhesive layer attached to an underside portion of the cover glass.

5. The method as recited in claim 3, the laminate structure comprising the optically clear plastic layer attached to the adhesive layer.

6. The method as recited in claim 5, wherein the laminate structure bonded to the display frame forms a housing for a portable electronic device.

7. The method as recited in claim 3, the display frame further comprising a second set of ultrasonic energy directors arranged in a second pattern and arranged to convert ultrasonic energy at a second frequency to a corresponding amount of thermal energy used to weaken the bond in a rework operation.

8. The method as recited in claim 3, wherein the first set of energy directors includes at least one ultrasonic energy director positioned approximately 45 degrees with respect to a corner of the display frame.

9. The method as recited in claim 4, wherein the adhesive layer and the optically clear plastic layer are simultaneously die cut.

10. A method of securing a cover glass to a frame member, the method comprising:
providing ultrasonic energy to:
a laminate structure comprising the cover glass, the frame member, and a thermally sensitive layer disposed between the cover glass and the frame member; and
a first energy director positioned on at least the one of the cover glass or the frame member, the first energy director configured to convert at least some of the ultrasonic energy to thermal energy, the thermal energy emitted from the first energy director melts a portion of the thermally sensitive layer thereby bonding the cover glass to the frame member.

11. The method as recited in claim 10, wherein an adhesive layer is disposed between the cover glass and the thermally sensitive layer.

12. The method as recited in claim 10, wherein the first energy director is one of a first plurality of energy directors, wherein the first plurality of energy directors convert the ultrasonic energy to thermal energy only in accordance with a first frequency range.

13. The method according to claim 12, wherein the first frequency range includes 30 kilohertz (kHz).

14. The method as recited in claim 12, further comprising providing ultrasonic energy to a second energy director, the second energy director configured to convert at least some of the ultrasonic energy to thermal energy, the thermal energy emitted from the second energy director melts a portion of the thermally sensitive layer thereby de-bonding the cover glass to the frame.

15. The method as recited in claim 14, wherein the second energy director is one of a second plurality of energy directors, wherein the second plurality of energy directors convert the ultrasonic energy to thermal energy only in accordance with a second frequency range.

16. The method as recited in claim 15, wherein the second frequency range is different from the first frequency range.

17. A laminate structure, comprising:
a first layer;
a second layer;
a first energy director configured to receive ultrasonic energy and convert at least some of the ultrasonic energy into thermal energy; and
a thermally sensitive layer, wherein a portion of the thermally sensitive layer melts in response to receiving thermal energy from the first energy director in order to bond the first layer to the second layer.

18. The laminate structure as recited in claim 17, further comprising:
a second energy director configured to receive ultrasonic energy and convert at least some of the ultrasonic energy into thermal energy, wherein the thermal energy received by the second energy director de-bonds the first layer from the second layer.

19. The laminate structure as recited in claim 18, further comprising:
wherein the first energy director converts ultrasonic energy into thermal energy only in response to a first frequency range;
wherein the second energy director converts ultrasonic energy into thermal energy only in response to a second frequency range; and
wherein the first frequency range is different from the second frequency range.

20. The laminate structure as recited in claim 19, further comprising a plurality of first energy directors and a plurality of second energy directors.
